(19) United States
(12) Patent Application Publication
(10) Pub. No.: US 2012/0291479 A1
(43) Pub. Date: Nov. 22, 2012

(54) Method and Apparatus For Forming Carbon Dioxide Pellets

(76) Inventors: Richard C. Moore, Milford, OH (US); Scott T. Hardoerfer, Milford, OH (US); Brandon R. Groves, Cincinnati, OH (US)

(21) Appl. No.: 13/475,454

(22) Filed: May 18, 2012

Related U.S. Application Data
(60) Provisional application No. 61/487,837, filed on May 19, 2011.

(51) Int. Cl. C01B 31/22

(52) U.S. Cl. 62/605

(57) ABSTRACT

The outer periphery of a pelletizer barrel is devoid of obstructions allowing the number, location and size of vents to be maximized, thereby improving the flow rate of gas being vented from the interior chamber, allowing increased efficiency in and of production of pellets. Screens on the vents are disposed adjacent the inner surface of the barrel sidewall, reducing the volume within which snow can accumulate, thereby avoiding reduction in the venting of gas from the interior chamber resulting from snow accumulation in the vent passageways.

The present invention claims priority from and incorporates by reference U.S. Provisional Patent Application, Ser. No. 61/487,837, filed on May 19, 2011, titled Method And Apparatus For Forming Carbon Dioxide Particles.

### TECHNICAL FIELD

The present invention relates to forming solid particles of a cryogenic material, and is particularly directed to a method and apparatus for forming carbon dioxide particles from liquid carbon dioxide.

### BACKGROUND OF THE INVENTION

Solid cryogenic material, such as solid carbon dioxide, has many uses. Solid carbon dioxide has long been used to maintain items, such as food or beverages at desirable cool temperatures. In certain food service applications, solid blocks, or cakes, of carbon dioxide have been used, disposed within an given volume adjacent the items sought to be maintained at or below a desired temperature. It is known to cut form carbon dioxide blocks of the desired size or to cut them from larger blocks. It is also known to form the desired sized blocks by reforming carbon dioxide particles into blocks.

Solid carbon dioxide particles have also been used in carbon dioxide particle blasting systems for several decades. Typically, carbon dioxide particles, whether granular or pellets, also known as blast media, are fed into a transport gas flow and are transported as entrained particles to a blast nozzle, from which the particles and transport gas exit, being directed toward a workpiece or other target.

Solid cryogenic particles, in particular but not limited to carbon dioxide particles, may be formed by many ways. Such solid particles may be formed by transforming liquid cryogenic material into small solid particles (“snow”) and compressing them into larger parts (“pellets”). For example, carbon dioxide pellets may be formed by producing carbon dioxide snow, such as by passing liquid carbon dioxide through a phase change nozzle such as is described in U.S. Pat. No. 5,018,667, and forming that snow into carbon dioxide pellets by forcing the snow through die openings, such as is described in U.S. Pat. Nos. 5,301,509 and 5,473,903. The gas phase is a byproduct of this process that accompanies the formation of the solid phase as snow. U.S. Pat. Nos. 5,018,667, 5,301,509 and 5,473,903, all of which are incorporated herein by reference.

As described in the '509 and '903 patents, with reference to FIGS. 1 and 2 thereof, a pelletizer may be used to change the phase of carbon dioxide from liquid to the solid phase as snow by passing the liquid carbon dioxide through a phase change device, such as a phase change nozzle, and directing the snow into the internal chamber of the barrel of the pelletizer. The flow rate of carbon dioxide into the internal chamber of the barrel is affected not only by the pressure of the carbon dioxide upstream of the phase change nozzle, but also by the internal pressure of the internal chamber. Downstream of the phase change nozzle, the gaseous portion of the carbon dioxide flow directly affects the internal pressure of the internal chamber. To reduce the internal chamber pressure, the gaseous carbon dioxide is vented out of the internal chamber, to reduce the backpressure resulting from the gaseous carbon dioxide flow. Vents are provided in the barrel adjacent the phase change nozzle to vent the gaseous carbon dioxide. Without the vents, the flow of solid and gas carbon dioxide into the internal chamber would be constricted, reducing the efficiency of the process.

A collector may located adjacent and surrounding the vents to collect the off gassing of the carbon dioxide from the vents. The collector includes screens located adjacent the vents allowing the gas to vent while retaining the snow within the barrel internal chamber. The screens are disposed at the periphery of the barrel, aligned with the vents. This location allows snow to accumulate in the “wells” created by the thickness of the barrel wall and the vent screen, the snow being pushed into the wells by the travel of the piston. The accumulated snow impedes the out flowing of the gas.

As can be seen in FIGS. 1 and 2 of the '509 and '903 patents, the barrel is retained between a plate and an end cap by elongated fastening rods. The rods, four in number, may present problems. Uneven tension and misalignment may negatively affect concentricity along the length of the barrel, which can present problems of undesirable contact and wear between the wall forming the barrel internal chamber and the piston. The locations of the rods about the exterior of the barrel affects the size and shape of the collector, and therefore affects the location and number of vents, since the rods interfere with a collector reaching vents disposed under the rods.

There is a need for a method and apparatus, and therefore are objects of the present invention, that provide improved venting of the gaseous faction of the flow downstream of the phase change nozzle from the internal chamber, that provide reduced pressure within the internal chamber of the barrel, that opens up the peripheral access to the barrel, that provide vents configured to remain free from substantial accumulation of snow, and that reduce the potential to cause misalignment between the barrel internal chamber and the piston and wear resulting from such misalignment.

Although the present invention will be described herein in connection with carbon dioxide, it will be understood that the present invention is not limited in use or application to carbon dioxide.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a perspective view of a pelletizer assembly constructed in accordance with teachings of the present invention.

FIG. 2 is a partially exploded perspective view of the pelletizer assembly of FIG. 1, showing the collectors, insert retainer, and insert exploded.

FIG. 3 is a side view of the pelletizer assembly of FIG. 1.

FIG. 4 is a cross-sectional view of the pelletizer assembly of FIG. 1 taken along its vertical center line.

FIG. 5 is a perspective view of the cross-sectional view shown in FIG. 4, showing the piston in its retracted or non-extended position.

FIG. 6 is the same as FIG. 5, except the piston is shown in an intermediate position.

FIG. 7 is an enlarged cross-sectional perspective view of the piston of the pelletizer assembly of FIG. 1.

FIG. 8 is a perspective view of the screen insert of the pelletizer assembly of FIG. 1.

FIG. 9 is a cross-sectional view of the pelletizer assembly of FIG. 1 taken through the longitudinal middle of the collectors.

FIG. 10 is a cross-sectional view of the pelletizer assembly of FIG. 1 and attached hydraulic cylinder taken at an angle of 25° from vertical.

FIG. 11 is an exploded side perspective view of the barrel adaptor plate of the pelletizer assembly of FIG. 1 and the die plate of FIG. 1.

Reference will now be made in detail to the present preferred embodiment of the invention, an example of which is illustrated in the accompanying drawings.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, an embodiment constructed according to the teachings of the present invention is described.

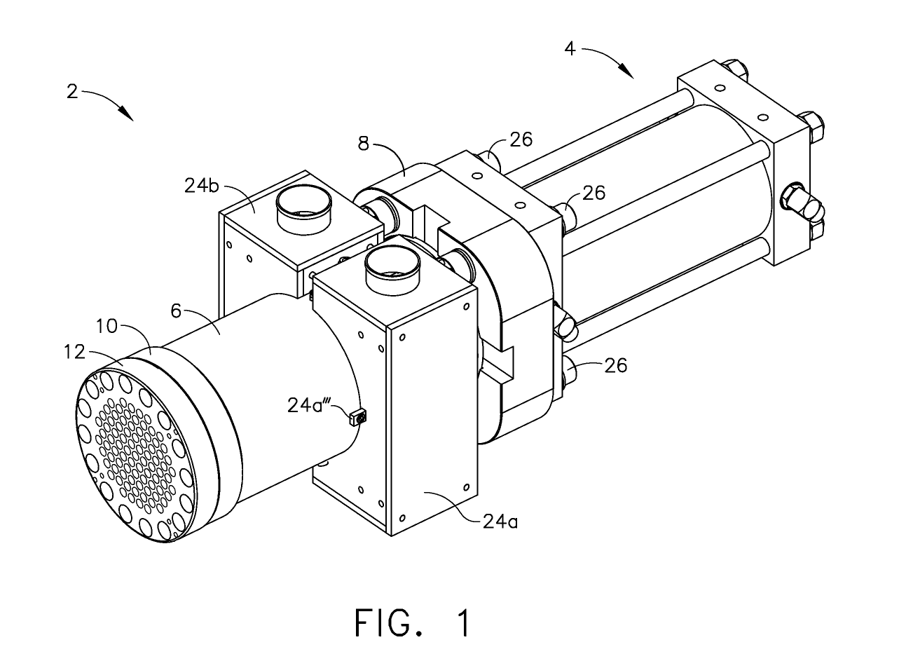

Referring to FIG. 1, there is shown pelletizer assembly, generally indicated at 2, connected to hydraulic cylinder assembly, generally indicated at 4. Any suitable hydraulic cylinder assembly may be used, or other device that is configured to move the piston (described below) of pelletizer assembly 2.

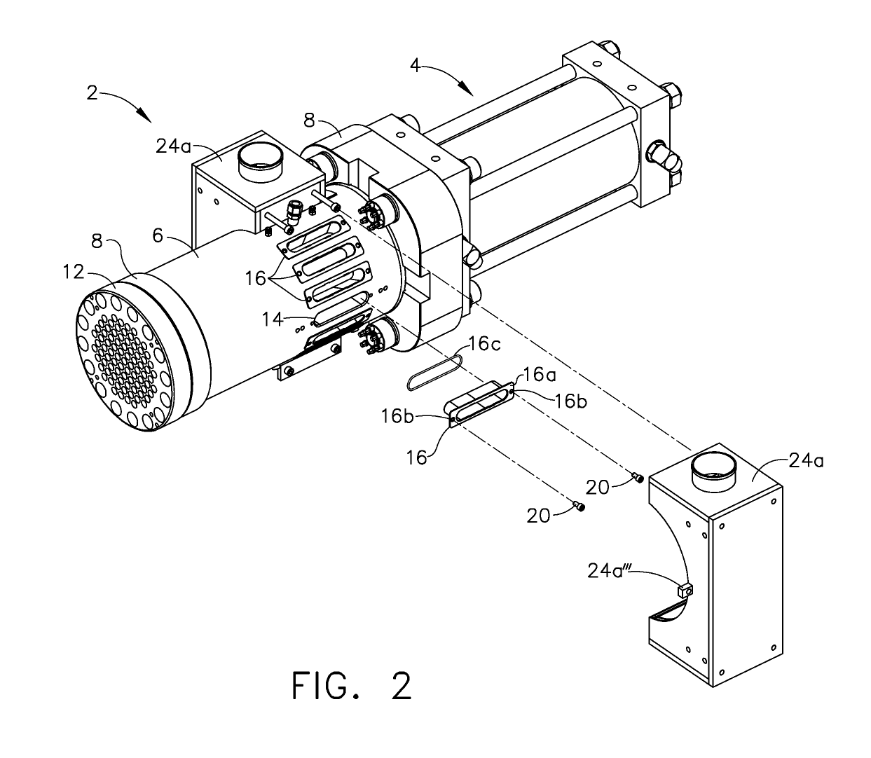

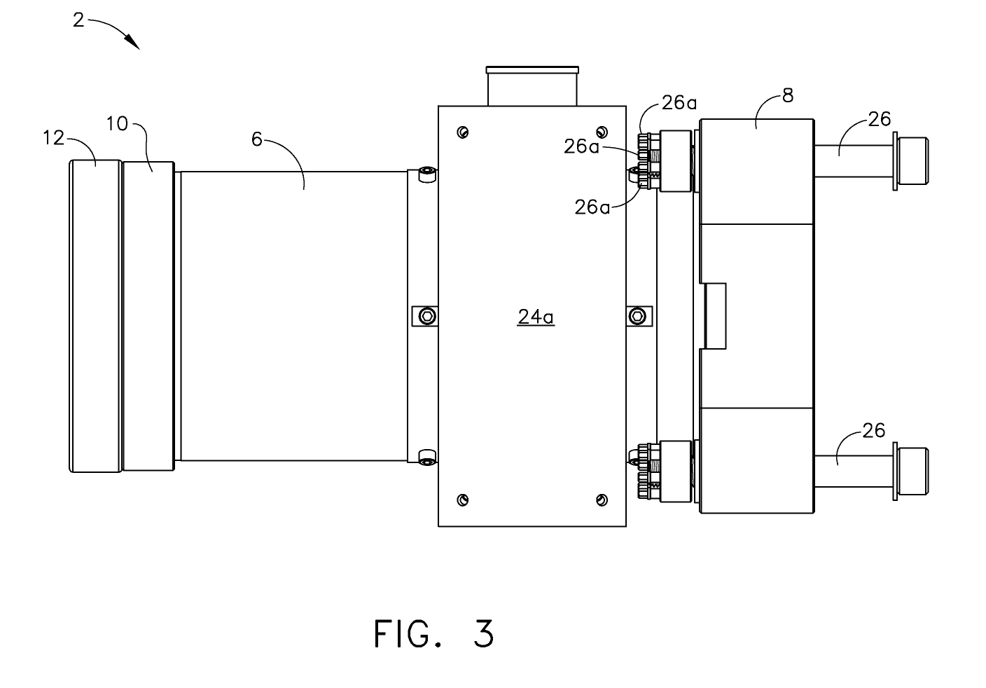

Referring also to FIGS. 2, 3 and 4, in the embodiment depicted, pelletizer assembly 2 includes barrel 6 connected at one end to end block 8 and connected at the other end to adaptor 10, and die 12 connected to adaptor 10. Barrel 6 may be made of any suitable material, such as A2 stainless steel. End block 8 may be made of any suitable material, such as nickel plated carbon steel. Adaptor 10 may be made of any suitable material, such as A4 stainless steel. Barrel 6 includes a plurality of spaced apart openings 14 which define passageways from interior chamber 6a through side wall 6b of barrel 6. Each opening 14 has a respective complementarily shaped insert 16, disposed therein. Inserts 16 may be retained in openings 14 by any suitable method and structure. In the embodiment depicted, inserts 16 may be individually secured to barrel 6 by respective threaded fasteners (not illustrated) extending through holes 16b respective in flanges 16a. Collectors 24a and 24b overlie inserts 16 and openings 14 such that gas venting therethrough flows into the interior of collectors 24a and 24b. Collectors 24a and 24b may be made of any suitable material, such as aluminum.

Pelletizer assembly 2 may be secured to hydraulic cylinder assembly 4 by any suitable means. In the embodiment depicted, end block 8 is secured to hydraulic cylinder 4 by a plurality of spaced apart fasteners 26. In this embodiment, fasteners 26 are multiple jackbolt tensioners in which include a plurality of jackbolts 26a are carried by a single threaded shaft and are tightened individually to tighten the single threaded shaft.

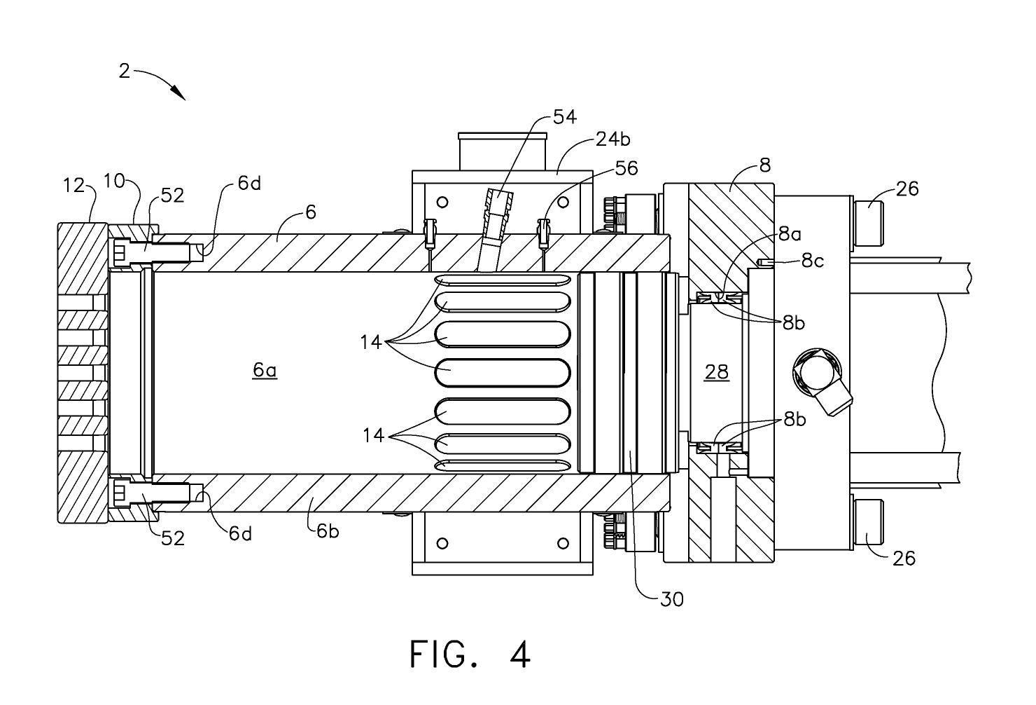

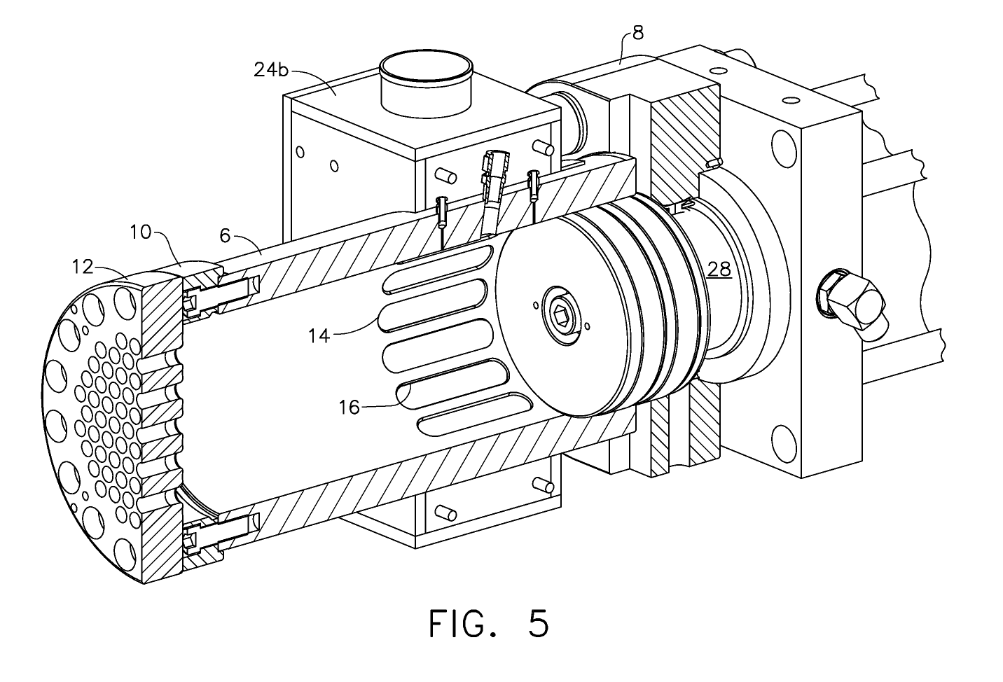

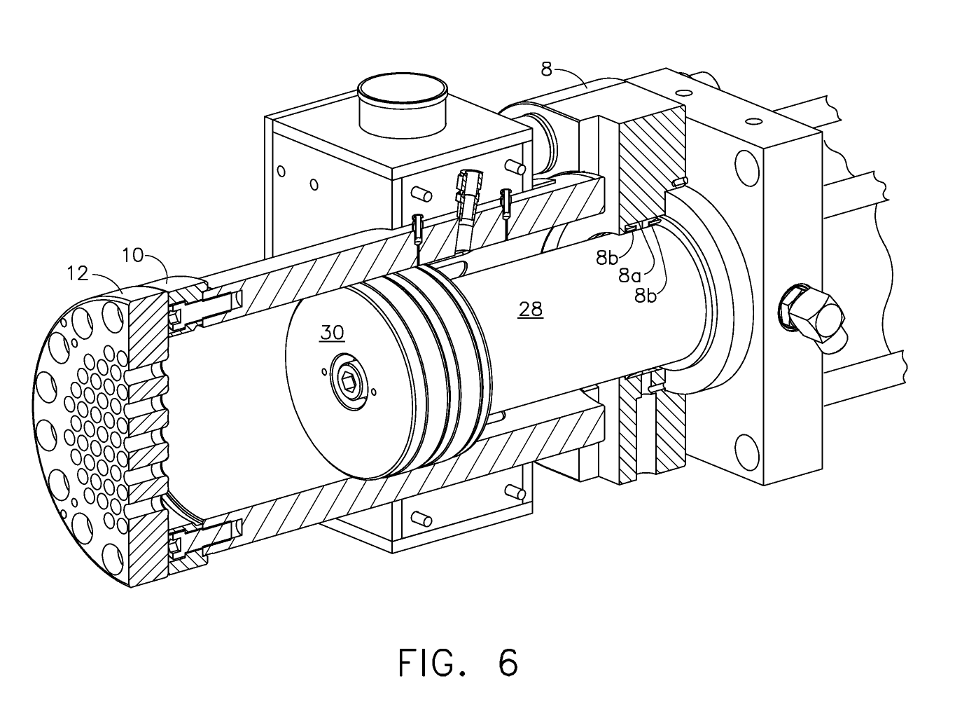

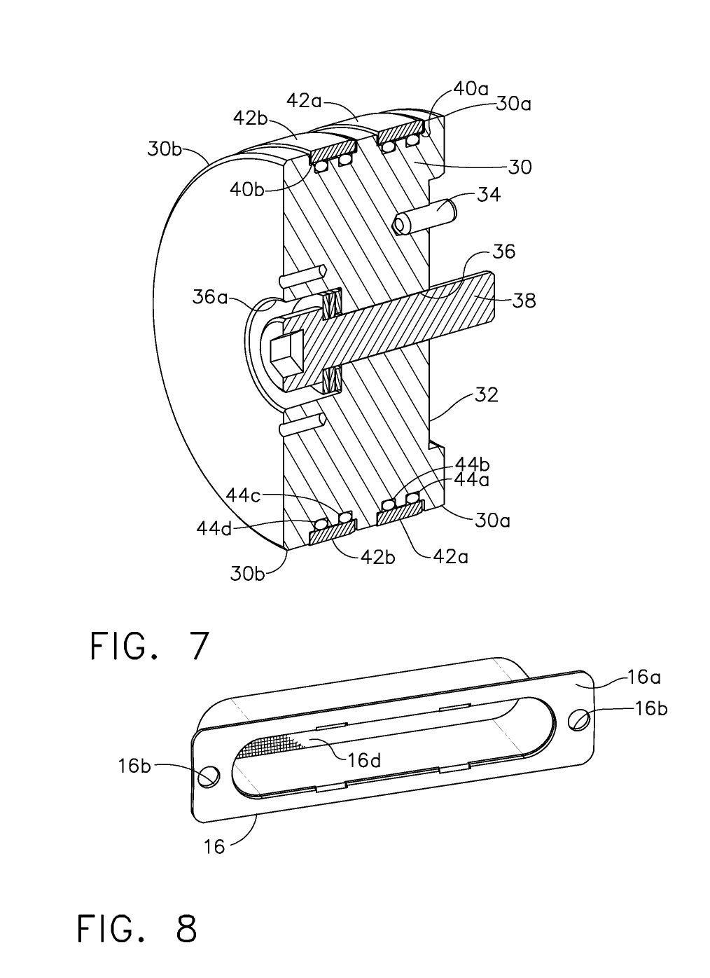

Referring to FIGS. 4, 5 and 6, end block 8 is aligned and located with respect to hydraulic cylinder assembly 4 in any suitable method, such as through the use of locating pins 8c. Rod 28 extends through bore 8a of end block 8. Seals 8b are disposed within bore 8a and sealingly engage the outer diameter of rod 28. Referring also to FIG. 7, piston 30 is disposed within interior chamber 6a, attached to the end of rod 28. On the side of piston 30 disposed rod 28, counterbore 32 is configured to receive the distal end of rod 28. Locating pin 34 may be used to align and limit rotation of piston 30 relative to rod 28. Piston 30 includes bore 36 through which fastener 38 extends and engages the distal end of rod 28 so as to secure piston 30 to rod 28. Bore 36 includes counterbore 36a which allows the head of fastener 28 to be recessed as shown.

Piston 30 includes two spaced apart grooves 40a and 40b in which respective wear bands 42a and 42b are disposed. Wear bands 42a and 42b may be made of any suitable material, such as nylon. Formed in the bottom of grooves 40a and 40b are O-ring grooves 44a, b, c and d in which O-rings 46a and 46b are disposed. The outer diameter of piston 30 is smaller than the inner diameter of barrel 6. Wear bands 42a and 42b, supported by O-rings 46a and 46b, allow piston 30 to float, minimizing contact between piston 30 and barrel 6 and allowing less precise alignment. Ends 30a and 30b of piston 30 are tapered, further reducing the potential for direct contact with barrel 6. Thus, as rod 28 is extended, the precision of the alignment required is less with this configuration.

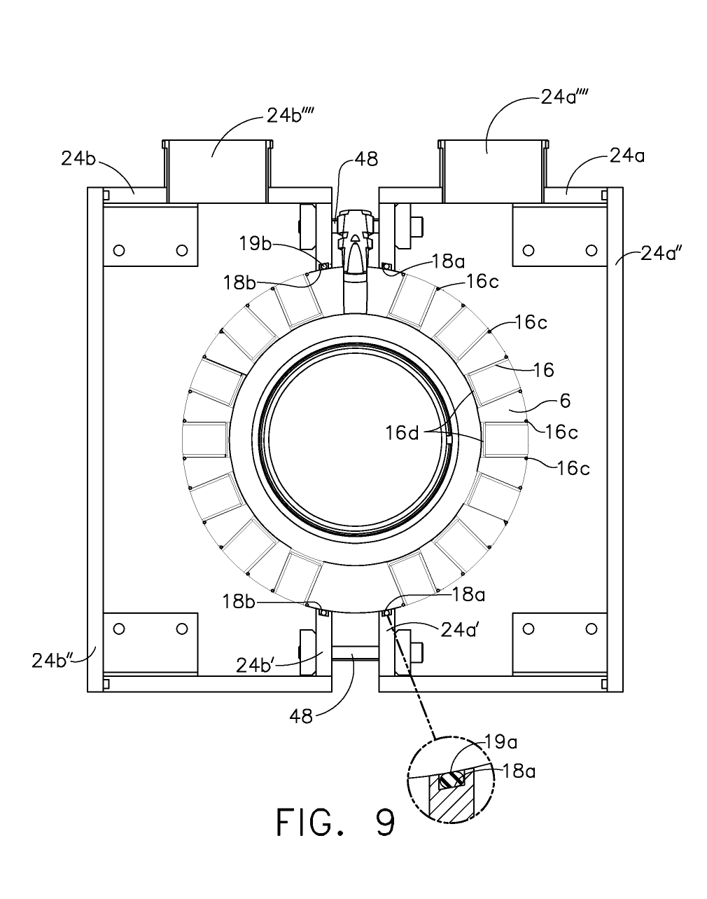

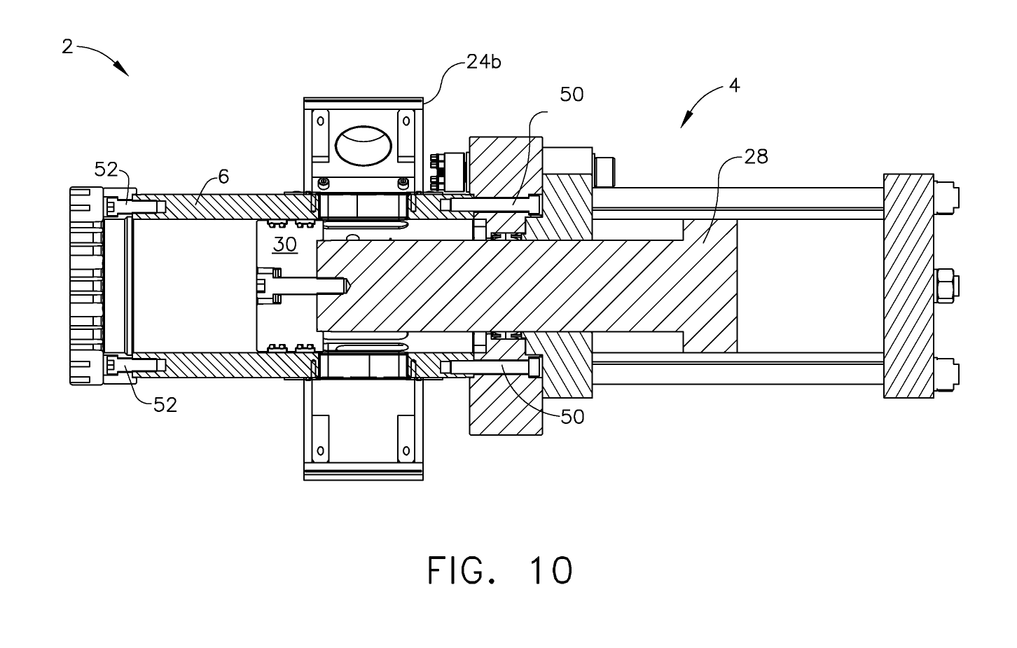

Referring to FIGS. 8 and 9, collectors 24a and 24b cover almost 360° of the periphery of barrel 6. Inserts 16 are shown disposed in openings 14, with respective O-rings 16c disposed between respective flanges 16a and sidewall 6b to provide a seal that prevents carbon dioxide snow from flowing between flanges 16a and openings 14. O-rings 16c may be made of any suitable material, such as nylon. Each insert 16 includes screen 16d at the bottom of the insert well. The openings in screens 16d are sized to allow gas to flow therethrough yet retain the solid snow. In the embodiment depicted, screens 16d are made of stainless steel and the opening size is 0.004 inches. Any suitable material and screen opening may be used. Screens 16d are located such that when inserts 16 are disposed in passageways 14, screens 16d are recessed slightly relative to inner surface 16d of sidewall 6b. Too much recess provides a volume for solid snow to accumulate and impede the gas flow through the passageways.

Collectors 24a and 24b may be retained in place by any suitable configuration. In the embodiment depicted, inner facing panels 24a′ and 24b′ of collectors 24a and 24b are connected to each other in a spaced apart arrangement by a plurality of fasteners 48, engaging the outer periphery of barrel 6. Access to fasteners 48 may be provided by removable outer panels 24a″ and 24b″. Collectors 24a and 24b may also include tabs (24′″ in FIGS. 1 and 2) secured by fasteners to barrel 6. Collectors 24a and 24b include gas collection ports 24a″″ and 24b″″, to which a collection hose (not shown) can be connected to collect the vented gas.

Collectors 24a and 24b include respective seal grooves 18a and 18b about their respective edges which are disposed adjacent the periphery of barrel 6. Respective seals 19a and 19b are disposed in seal grooves 18a and 18b. Any suitable material and shape may be used. In the embodiment depicted, seals 19a and 19b are nylon O-ring cord.

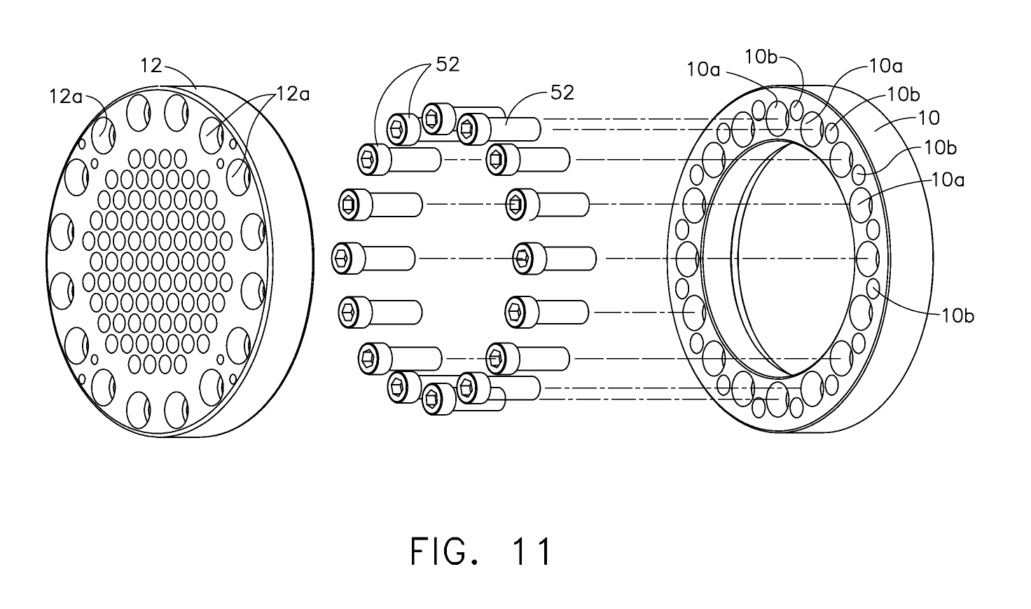

Referring to FIG. 10, the connection, for the embodiment depicted, between barrel 6 and end block 8 is visible. A plurality of fasteners 50 extend through respective holes in end block 8 to engage barrel 6. In the embodiment depicted, twelve fasteners 50 are disposed at 22.5° angles therebetween, with no fasteners present at 0°, 90°, 180° and 270°. Any suitable configuration may be used to secure pelletizer assembly 4 to hydraulic cylinder assembly 6.

Referring to FIG. 11, adaptor 10 may be secured to barrel 6 in any suitable method.

In the embodiment depicted, there are sixteen spaced apart countersunk bores 10a that align with threaded bores 6d (see FIG. 4) in the distal end of barrel 6. Fasteners 52 are used to secure adaptor 10 to barrel 6.

Adaptor 10 provides the mount for the die through which solid snow is extruded. In the embodiment depicted, die 12 is a solid plate with openings formed therethrough. Any suitable configuration of die 12 may be used, such including the use of a backing plate. Die 12, as depicted, includes sixteen spaced apart countersunk bores 12, which align with threaded bores 10b in adaptor 10. Fasteners (not shown) are used to secure die 12 to adaptor 10. With this configuration, potential damage resulting from changing dies 12 occurs only to adaptor 10, saving the more expensive barrel 6 from such damage. In the event that adaptor 10 becomes worn or damage beyond use, a new adaptor may be installed to the distal end of barrel 6.

To create pellets, pressurized liquid, such as liquid carbon dioxide, is forced through phase change nozzle 54 (see FIG. 4), resulting in solid snow and gas flowing into interior chamber 6a. Pressure within interior chamber 6a is monitored by a pressure gage (not shown) in communication with interior chamber 6a through port 56. If the pressure within the interior chamber 6a exceeds a limit, such as 16 PSIG, the flow rate of liquid may be decreased, and thereafter increased if the pressure drops below a limit. Although this is a manual procedure in the depicted embodiment, the control could be automated. Screens 16d block snow from exiting interior chamber 6a, while allowing gas to vent therethrough. When sufficient snow has accumulated, piston 30 is advanced, compressing the snow against previously compressed snow, resulting in the solid material adjacent die 12 being compressed and forced through the openings in die 12, producing solid, dense material at the exit of die 12, which may be allowed to break naturally or a device to break the material into pellets may be utilized, such as a rotating blade (not shown).

As can be seen in FIGS. 1 and 2, pelletizer assembly 4 does not have elongated fastening rods extending the length of barrel 6 as is found in the prior art. In the prior art, such fastening rods interfered with the placement of gas collection structure restricting the location, size and number of vents. By keeping the outer periphery of barrel 6 devoid of any or almost any obstructions that restrict the venting, the vent location, size and number can be optimized or maximized and collectors can be disposed substantially about the entire periphery of barrel 6 to collect vented gas. This improves the gas flow out of interior 6a, allowing a higher flow rate of liquid into phase change nozzle 54, increasing the production rate of snow and therefore pellets.

The foregoing description of an embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. Although only a limited number of embodiments of the invention is explained in detail, it is to be understood that the invention is not limited in its scope to the details of construction and arrangement of components set forth in the preceding description or illustrated in the drawings. The invention is capable of other embodiments and of being practiced or carried out in various ways. Also, in describing the preferred embodiment, specific terminology was used for the sake of clarity. It is to be understood that each specific term includes all technical equivalents which operate in a similar manner to accomplish a similar purpose. It is intended that the scope of the invention be defined by the claims submitted herewith.

1. A pelletizer for producing pellets from a cryogenic material, said pelletizer comprising:
a. a barrel configured to receive particles of a having:
i. a first end;
ii. a second end;
iii. an interior chamber defining an inner surface and a longitudinal axis; and
iv. an exterior peripheral surface;
b. end block disposed adjacent said first end;
c. a first plurality of fasteners connecting said barrel to said end block;
d. a die plate carried by said second end, said die plate having a plurality of die openings;
e. a piston disposed in said interior chamber and configured to urge cryogenic material disposed within said interior chamber against said die plate and through said plurality of die openings thereby creating force against said die plate; and
f. movement of said die plate relative to said piston being resisted by substantially all of said force being transmitted by said barrel to said end block through said first plurality of fasteners.

2. The pelletizer of claim 1, comprising a second plurality of fasteners connecting said die plate directly to said second end.

3. The pelletizer of claim 1, further comprising:
a. an adaptor disposed between said die plate and said second end;
b. a second plurality of fasteners connecting said adaptor to said second end; and
c. a third plurality of fasteners connecting said die plate to said adaptor.

4. The pelletizer of claim 1, comprising a plurality of passageways extending between said interior chamber and said exterior peripheral surface.

5. The pelletizer of claim 4, wherein said plurality of passageways have a total surface area configured to minimize backpressure within said interior chamber.

6. The pelletizer of claim 4, wherein said passageways are generally longitudinally aligned in a region of said inner surface.

7. The pelletizer of claim 6, wherein said plurality of passageways have a total surface area which comprises a significant portion of the region of said inner surface.

8. The pelletizer of claim 4, wherein each passageways includes a respective screen which is slightly recessed relative to said inner surface.

9. The pelletizer of claim 4, comprising at least one collector disposed adjacent said exterior peripheral surface and configured to collect any gas flowing out of said plurality of vents.

10. The pelletizer of claim 9, wherein said at least one collector covers almost 360° of said exterior peripheral surface.

11. A pelletizer for producing pellets from a cryogenic material, said pelletizer comprising:
a. a barrel configured to receive particles of said cryogenic material, said barrel comprising:
i. a first end;
ii. a second end;
iii. an interior chamber defining an inner surface; and
iv. an exterior peripheral surface;
b. a die plate carried by said second end, said die plate having a plurality of die openings;
c. a piston disposed in said interior chamber; and
d. a plurality of passageways extending between said inner surface and said exterior peripheral surface, each passageway including a respective screen which is slightly recessed relative to said inner surface.

12. A pelletizer for producing pellets from a cryogenic material, said pelletizer comprising:
a. a barrel configured to receive particles of said cryogenic material, said barrel comprising:
i. a first end;
ii. a second end;
iii. an interior chamber defining an inner surface; and
iv. an exterior peripheral surface;
b. a die plate carried by said second end, said die plate having a plurality of die openings;
c. a piston disposed in said interior chamber;
d. a plurality of passageways extending between said inner surface and said exterior peripheral surface; and
e. at least one collector disposed adjacent said exterior peripheral surface and configured to collect any gas flowing out of said plurality of vents. wherein said at least one collector covers almost 360° of said exterior peripheral surface.

13. A pelletizer for producing pellets from a cryogenic material, said pelletizer comprising:
a. a barrel configured to receive particles of said cryogenic material, said barrel comprising:
i. a first end;
ii. a second end;
iii. an interior chamber defining an inner surface; and
iv. an exterior peripheral surface;
b. a die plate carried by said second end, said die plate having a plurality of die openings;
c. a piston disposed in said interior chamber; and
d. a plurality of passageways extending between a region of said inner surface and said exterior peripheral surface, said plurality of passageways having a total surface area which comprises a significant portion of said region.

14. A pelletizer for producing pellets from a cryogenic material , said pelletizer comprising:
a. a barrel configured to receive particles of said cryogenic material, said barrel comprising a first end;
b. an adaptor connected to said first end by a first plurality of fasteners; and
c. a die plate connected to said adaptor by a second plurality of fasteners.

15. A method for producing pellets from a cryogenic material, said method comprising the steps of:
a. flowing liquid cryogenic material at a flow rate through a phase change nozzle so as to flow solid particles of the cryogenic material and gas cryogenic material into an interior chamber of a pelletizer;
b. monitoring pressure within said interior chamber during step a;
c. adjusting the flow rate based on the pressure within the interior chamber.

16. The method of claim 15, wherein the step of adjusting comprises the step of decreasing the flow rate if said pressure is above a first predetermined pressure.

17. The method of claim 16, wherein the step of adjusting comprises the step of increasing the flow rate if said pressure is below a second predetermined pressure.

18. The method of claim 17, wherein said first and second predetermined pressures are the same.

19. The method of claim 15, wherein the step of adjusting comprises the step of increasing the flow rate if said pressure is below a first predetermined pressure.
